(19) United States
(12) Patent Application Publication
(10) Pub. No.: US 2016/0092807 A1
(43) Pub. Date: Mar. 31, 2016

(54) Automatic Detection and Resolution of Pain Points within an Enterprise

(71) Applicant: International Business Machines Corporation, Armonk, NY (US)

(72) Inventors: Victor Fernandes Cavalcante, Campinas (BR); Guilherme Steinberger Elias, Sumare (BR); Marcos Vinicius Landivar Paraiso, Campinas (BR); Sergio Varga, Campinas (BR)

(21) Appl. No.: 14/496,223

(22) Filed: Sep. 25, 2014

(51) Int. Cl. G06Q 10/06

(52) U.S. Cl. CPC G06Q 10/0635

(57) ABSTRACT

Methods, systems, and computer program products for automatic detection and resolution of pain points within an enterprise are provided herein. A method includes collecting multiple items of pain point data from multiple individuals across multiple parts of an organization, wherein said pain point data comprise information pertaining to one or more issues negatively impacting operations within the organization; automatically validating the collected pain point data via one or more items of evidence; correlating two or more of the multiple items of pain point data across two or more of the multiple parts of the organization; and automatically outputting, to an individual within the organization, a recommendation for resolving a submitted query related to an item of pain point data based on said correlating.

### FIELD OF THE INVENTION

Embodiments of the invention generally relate to information technology (IT), and, more particularly, to enterprise management technology.

### BACKGROUND

Detecting pain points from any part of an enterprise or organization can be an important aspect of enterprise managerial strategies, particularly within the context of large enterprises or organizations. As used herein, a pain point refers to a problem, real or perceived, impacting overall efficiency and/or productivity within an enterprise. Accordingly, a need exists for techniques to determine and/or identify pain points in a broad scope of an enterprise or organization structure, as well as the relative importance of each such pain point within the enterprise or organization structure. Further, a need exists for techniques to detect opportunities of investment to resolve identified pain points, as well as to detect opportunities for solution reuse to solve the identified pain points.

### SUMMARY

In one aspect of the present invention, techniques for automatic detection and resolution of pain points within an enterprise are provided. An exemplary computer-implemented method can include steps of collecting multiple items of pain point data from multiple individuals across multiple parts of an organization, wherein said pain point data comprise information pertaining to one or more issues negatively impacting operations within the organization; automatically validating the collected pain point data via one or more items of evidence; correlating two or more of the multiple items of pain point data across two or more of the multiple parts of the organization; and automatically outputting, to an individual within the organization, a recommendation for resolving a submitted query related to an item of pain point data based on said correlating.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating an example embodiment of the invention;

FIG. 2 is a diagram illustrating system architecture, according to an embodiment of the invention;

FIG. 3 is a diagram illustrating a correlation technique, according to an embodiment of the invention;

FIG. 4 is a diagram illustrating an example embodiment of the invention;

FIG. 5 is a flow diagram illustrating an example question and answer analysis, according to an embodiment of the invention;

FIG. 6 is a flow diagram illustrating input normalization, according to an embodiment of the invention;

FIG. 7 is a diagram illustrating an example aspect of the invention;

FIG. 8 is a flow diagram illustrating correlating pain points, according to an embodiment of the invention;

FIG. 9 is a flow diagram illustrating identifying solution opportunities, according to an embodiment of the invention;

FIG. 10 is a flow diagram illustrating techniques according to an embodiment of the invention; and

FIG. 11 is a system diagram of an exemplary computer system on which at least one embodiment of the invention can be implemented.

### DETAILED DESCRIPTION

As described herein, an aspect of the present invention includes cross-enterprise correlation techniques for automatic assistance in detecting and resolving pain points within an enterprise. At least one embodiment of the invention includes aggregating information pertaining to the pain points and respective organization structure for correlating common pain points across areas of the organization, and calculating the different levels of impacts associated with each of the pain points.

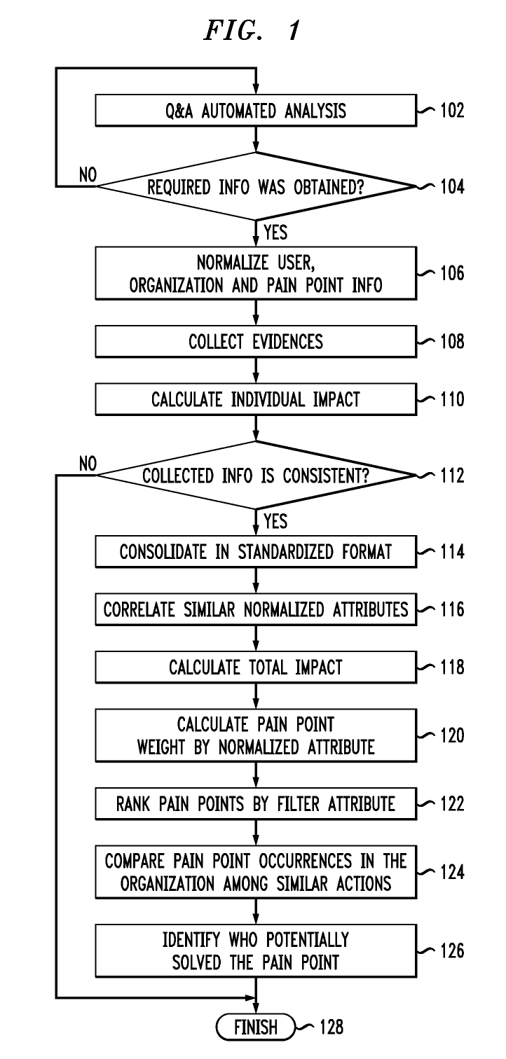

FIG. 1 is a flow diagram illustrating an example embodiment of the invention. By way of illustration, FIG. 1 depicts a technique to identify, correlate and rank pain point data from many levels within an organization structure, and to recommend reuse of one or more solutions across portions or divisions of the organization. As illustrated, step 102 includes performing an automated question and answer (Q & A) analysis, which can be carried out via one or more learning adaptation techniques (for example, questions are derived based on inferences from previous responses).

Such questions can be related to any issue that affects productivity and/or the organization. By way of example, a user, who can include anyone from the organization or someone specific related to a quality team with enterprise-level needs, can ask the question(s). Accordingly, the user will provide selected question(s) to a system interface, which can leverage an internal survey method such as a policy-based method, questions and answer learning adaptation, etc.

In step 104, a determination is made as to whether required information was obtained during the question and answer analysis. If no (that is, required information was not obtained), then the sequence of FIG. 1 returns to step 102. If yes (that is, required information was obtained), then the sequence continues to step 106, which includes normalizing user, organization, and pain point information obtained from the question and answer analysis.

Step 108 includes collecting evidences, and step 110 includes calculating the individual impact of the collected evidences. Step 110 can include defining the impact of the individual pain point based on information provided by the user as well as the collected evidence (such as, for example, the frequency per an interval of time versus effort in a given unit of time, percentage of time spent by month, etc.). Additionally, evidences generally include detailed information about the pain point which can be collected automatically. As such, collecting evidences can include, for example, detecting what kinds of tools are running in the user's machine, allowing the user to provide evidences, and/or obtaining evidence data from local or remote data sources based on the context.

In step 112, a determination is made as to whether the collected information/evidences is consistent with the given pain point. If no (that is, the collected information is not consistent), then the sequence ends at step 128. If yes (that is, the collected information is consistent), then the sequence continues to step 114, which includes consolidating and/or normalizing the information in a standardized format (such as text data, extensible markup language (XML), JavaScript Object Notation (JSON), relational database tables, etc.). Step 116 includes correlating similar normalized attributes among the information. Such attributes include pain points attributes (for example, category, activities, tasks, tags), and in at least one embodiment of the invention, a given attribute that can be used to be the same pain point attribute in order to enable correlation among different parts of the organization.

Step 118 includes calculating the total impact of the pain point, and step 120 includes calculating a pain point weight by normalized attribute. The weight is based on the impact of the normalized attribute related to the entire organization. Accordingly, while step 118 includes defining the total impact of a single given attribute, step 120 includes weighting the pain point comparing all attributes. Step 122 includes ranking pain points by filtering attributes. Additionally, step 124 includes comparing pain point occurrences within the organization among similar actions, and step 126 includes identifying the one or more individuals who potentially solved the pain point within the organization. In at least one embodiment of the invention, the individuals are identified by searching a pain point database and identifying which pain point was recorded as low impact and/or low weight, or by identifying areas in the organization for the same attribute wherein no pain point was reported for such an attribute. Further, as noted above, step 128 includes finishing the sequence.

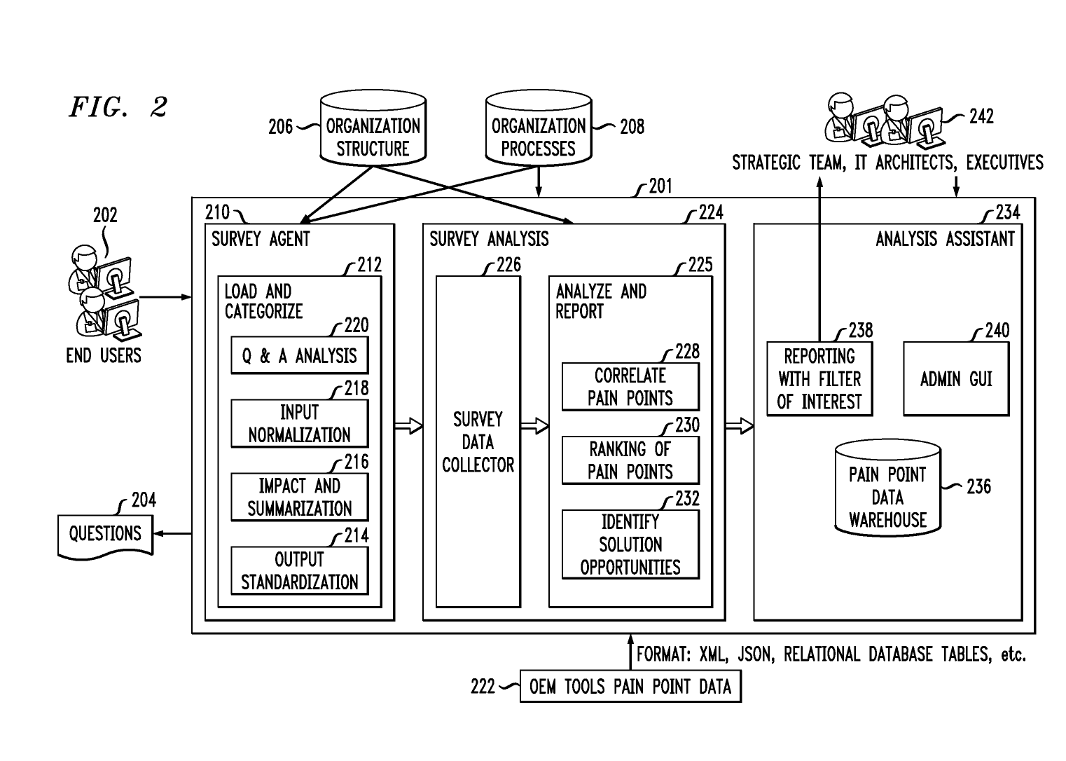

FIG. 2 is a diagram illustrating system architecture, according to an embodiment of the invention. By way of illustration, FIG. 2 depicts a pain point management component 201, end users 202, other users 242 (such as a strategic team, IT architects, and/or executives), an organization structure database 206, an organization processes database 208, and an enterprise manufacturer (OEM) tools pain point data component 222. The pain point management component 201 includes a survey agent module 210, a survey analysis module 224 and an analysis assistant module 234. The survey agent module 210 includes a load and categorization sub-module 212, which includes a question and answer analysis component 220, an input normalization component 218, an impact and summarization component 216, and an output standardization component 214. The survey agent 210 outputs questions 204 to end users 202, who, in return, provide answers to the survey agent 210.

Also, the survey analysis module 224 includes a survey data collector component 226 as well as an analysis and reporting sub-module 225. The analysis and reporting sub-module 225 includes a pain point correlation component 228, a pain point ranking component 230, and a solution opportunity identification component 232. The survey analysis module 224 additionally receives input from the OEM tools pain point data component 222. By way of example, any tool that collects pain points (a survey tool, for instance) can also provide pain point information.

The analysis assistant module 234 includes a pain point data warehouse 236, a reporting sub-module 238 (which can include capabilities of reporting with a filter of interest), and an administrator graphical user interface (GUI) 240. The arrows in FIG. 2 represent the logical flow of an example embodiment of the invention.

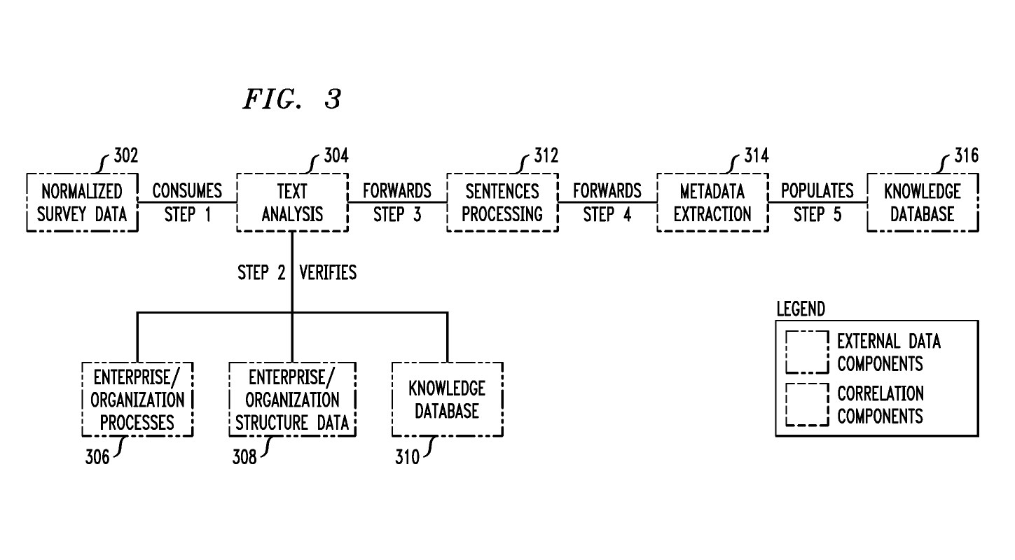

FIG. 3 is a diagram illustrating a correlation technique, according to an embodiment of the invention. By way of illustration, FIG. 3 depicts a survey data normalization component 302, a text analysis component 304, an enterprise/organization processes database 306, an enterprise/organization structured data database 308, a knowledge database 310, a sentence processing component 312, a metadata extraction component 314, and knowledge database 316. As noted in FIG. 3, the survey data normalization component 302, the enterprise/organization processes database 306, the enterprise/organization structured data database 308, knowledge database 310 and knowledge database 316 are external data components, while the text analysis component 304, the sentence processing component 312 and the metadata extraction component 314 are correlation components.

As also noted, FIG. 3 includes notations for five steps, described as follows. Step 1 includes a process wherein the normalized data entered are consumed by the text searching process. Step 2 includes a process wherein the data are read, analyzed and summarized; classified into pain point categories; and a determination is made as to whether the metadata already exists in the corresponding databases. Step 3 includes processing of the text (or sentence). Step 4 includes metadata extraction processing, wherein metadata is extracted, categorized, summarized and created. Further, step 5 includes populating normalized data into a knowledge database used by one or more embodiments of the invention.

As additionally detailed herein, the text analysis component 304 carries out actions that include obtaining survey data, reading, analyzing and summarizing such survey data, classifying the survey data in pain point categories, and determining if corresponding metadata already exists in one or more relevant databases. Also, the sentence processing component 312 carries out actions such as receiving a given sentence of text, parsing the sentence, reading rules for paraphrasing, reading relevant sections of a thesaurus, reading one or more stop-words, planning the given content, surface realization, and generating a set of new sentences. Further, the metadata extraction component 314 carries out actions including pre-processing pain point data, assigning weights to each term in the data, categorizing the data, summarizing the data, creating relevant metadata, and converting the metadata to resource description framework (RDF)/extensible markup language (XML) syntax.

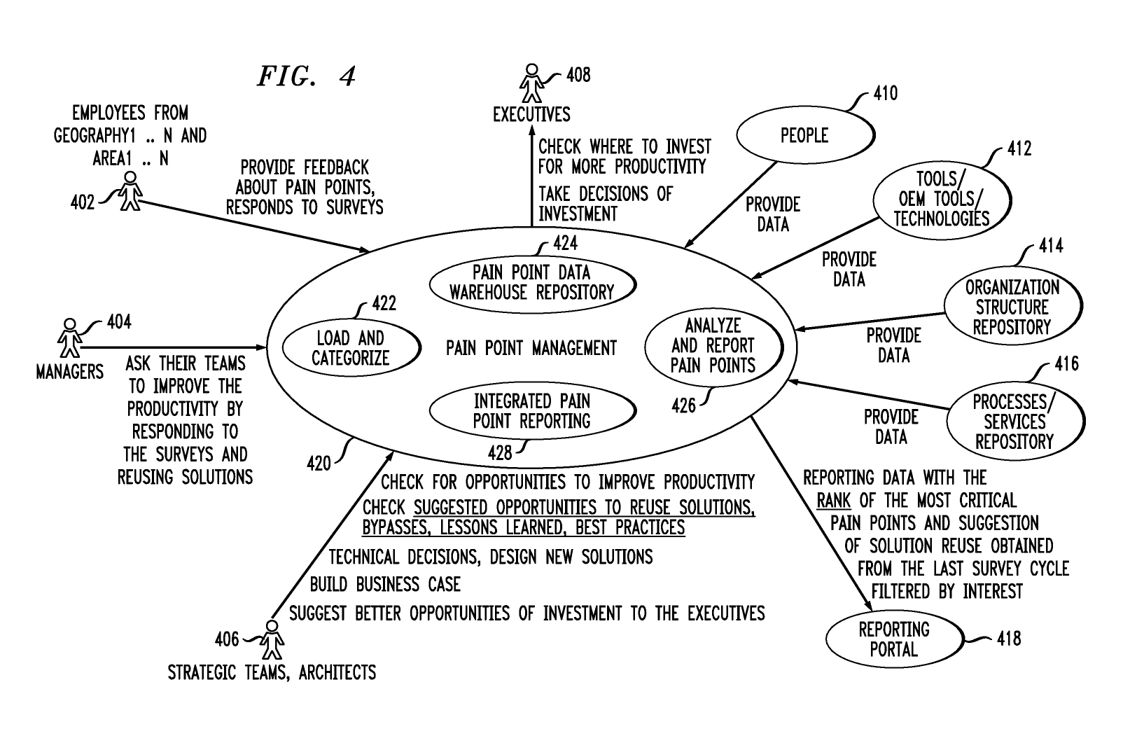

FIG. 4 is a diagram illustrating an example embodiment of the invention. By way of illustration, FIG. 4 depicts a pain point management system 420, employees 402 from geography 1 to N and area 1 to N, managers 404, executives 408, and strategic teams (and/or IT architects) 406. The pain point management system 420 includes a load and categorization component 422, a pain point data warehouse repository 424, a pain point analysis and reporting component 426, and an integrated pain point reporting component 428. Responses (for example, employee responses) are stored in the pain point data warehouse repository 424 with a different normalized format that allows such responses to be correlated as knowledge across the enterprise. Integrated reporting component 428 is the component responsible for being the back-end system for the reporting portal, and also interfaces with a pain point repository and enables the report generation capability of one or more embodiments of the invention.

The employees 402 provide feedback pertaining to pain points, responding to a broad scope of survey. The feedback data are validated and standardized by the pain point management system 420, and related evidences are collected as well. The managers 404 ask their teams (such as employees 402) to facilitate improvement in productivity by responding to the surveys and reusing one or more pain point solutions. Strategic teams 406 check for opportunities to improve enterprise productivity by, for example, examining suggested opportunities to reuse pain point solutions, bypasses, lessons learned, best practices, etc. Also, the strategic teams 406 suggest opportunities for investment to the executives 408, who ultimately execute investment decisions.

FIG. 4 also depicts additional people 410, tools (such as OEM tools) 412, an organization structure repository 414 and a processes and/or services repository 416, which can all provide data to the pain point management system 420. In connection with FIG. 4, people 410 refer to any other user that can provide pain point-specific information and/or details. Additionally, tools 412 refer to any existing tool that collects pain points (a survey tool, for instance) and can also provide pain point information.

Further, FIG. 4 depicts a reporting portal 418, which can be utilized to automatically report data with the rank of the most critical pain points, as well as to report suggestions for solution reuse obtained from previous survey cycles, filtered by interest. Such filtering can include, for example, filtering based on cost amount, level of business impact, by area, by location, level of variation of impact in the organization, areas with similar pain points, etc.

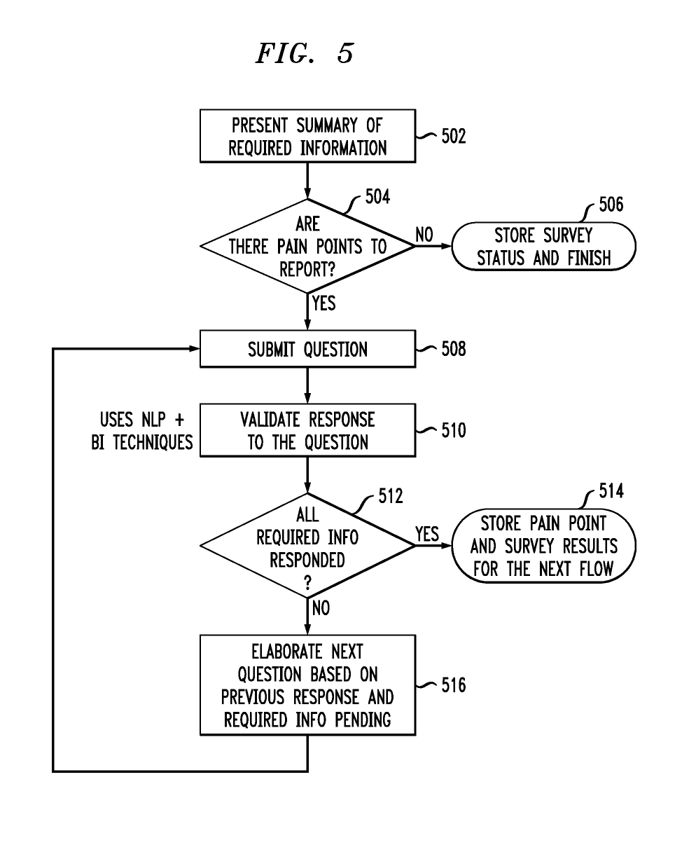

FIG. 5 is a flow diagram illustrating an example question and answer analysis, according to an embodiment of the invention. Step 502 includes presenting a summary of required information. Examples of required information can include a pain point title, a summarized pain point description, a pain point use case example, applications, components, areas and/or processes affected by a pain point, pain point frequency, and pain point waste time. Step 504 includes determining whether the information includes pain points that are to be reported. If no (that is, there are no pain points to report), then the survey status is stored and the sequence ends at step 506. If yes (that is, there are pain points to report), step 508 includes submitting a question to end users.

Step 510 includes validating a response to the question, for example, using natural language processing (NLP) and business intelligence (BI) techniques. Step 512 includes determining whether all required information was included in the response. If yes (that is, all required information was included), then the pain point and survey results are stored and the sequence ends at step 514. If no (that is, all required information was not included in the response), then the sequence continues to step 516, which includes elaborating to a next question based on the (previous) response and pending required information. Accordingly, the techniques then return to submitting a question in step 508.

Referring to step 516, the elaboration step can be carried out using NLP techniques along with methods of artificial intelligence. If the context of a response is not understood, then one or more embodiments of the invention can include reformulating the question to be more detailed, and the questions are formulated until key information is obtained.

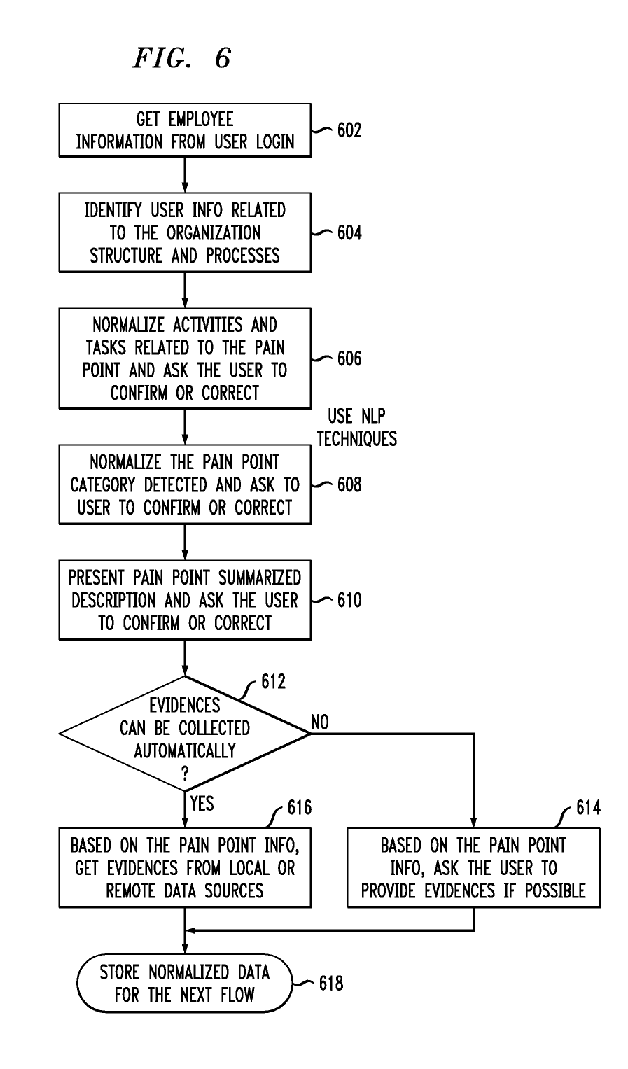

FIG. 6 is a flow diagram illustrating input normalization, according to an embodiment of the invention. Step 602 includes obtaining employee information from a user login. Examples of user information can include employee identifier (ID), employee job role, employee location, employee area in the enterprise, and employee activities within the area. Step 604 includes identifying user information that is related to the organization/enterprise structure and processes. Step 606 includes normalizing (using, for example, NLP techniques) activities and tasks related to a given pain point and querying the user (that is, the employee as noted in step 602) to confirm or correct the normalization.

Step 608 includes normalizing the pain point category detected and querying the user to confirm or correct the normalization. During step 606, a set of categories can be detected and collected. Step 610 includes presenting a summary of the pain point description and querying the user to confirm or correct the summer. Further, step 612 includes determining whether evidences can be automatically collected. If no (that is, evidences cannot be automatically collected), then the sequence continues to step 614, which includes querying the user to provide evidences (if possible) based on the pain point description. If yes (that is, evidences can be automatically collected), then the sequence continues to step 616, which includes obtaining such evidences (based on the pain point description) from a local or remote data source. Subsequent to both step 614 and step 616, step 618 includes storing normalized pain point data for a subsequent iteration.

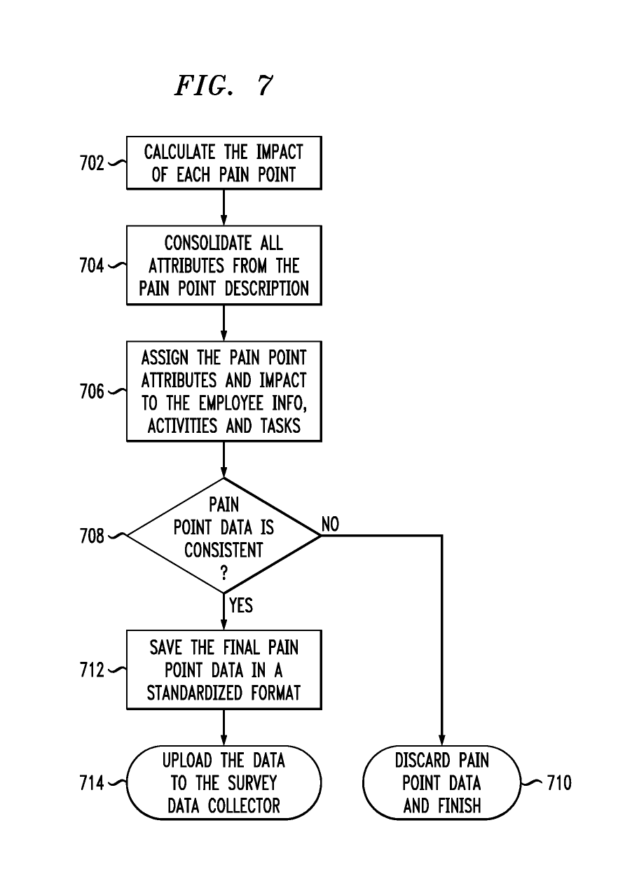

FIG. 7 is a diagram illustrating an example aspect of the invention. Step 702 includes calculating the impact of each pain point. Examples of impact parameters can include the pain point frequency per interval of time (day or month versus an effort in units of seconds, minutes or hours, percentage of time spent by month, etc.). Step 704 includes consolidating all attributes from the pain point descriptions, and step 706 includes assigning the pain point attributes an impact calculations to given employee information, activities, and/or tasks.

Step 708 includes determining whether the pain point data are consistent with collected evidences. If no (that is, the pain point data are not consistent), step 710 includes discarding the pain point data and ending the sequence. If yes (that is, the pain point data are consistent), then the sequence continues to step 712, which includes saving the final pain point data in a standardized format. Further, step 714 includes uploading the pain point data to a survey data collector.

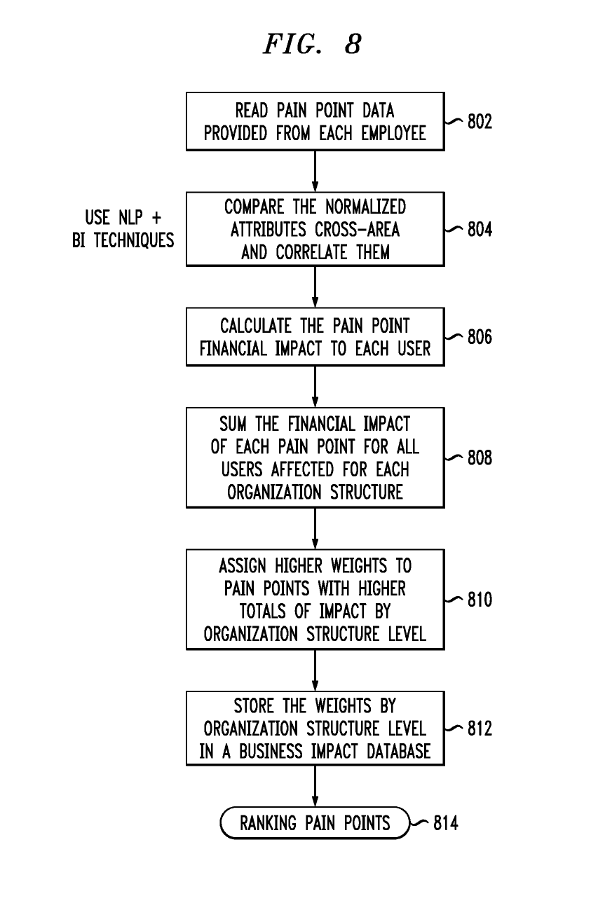

FIG. 8 is a flow diagram illustrating correlating pain points, according to an embodiment of the invention. Step 802 includes reading pain point data provided from each of one or more employees. Step 804 includes comparing the normalized pain point attributes across areas and correlating one or more of those attributes (using, for example, NLP and BI techniques). Example of comparison include identifying similar categories of pain points, similar pain point attributes, areas, processes, activities and/or tasks provided by different employees and/or organization departments.

Step 806 includes calculating the financial impact of each pain point for each user. By way of illustration, an example of pain point financial impact for one user can include the amount of time spent by the user with the pain point, multiplied by the quantity of occurrences of the pain point in an interval of time, multiplied by the employee rate per hour, multiplied by the direct business impact factor. As used herein, the direct business impact factor can include a fixed variable defined by the organization (for example, defined per pain point). Additionally, step 808 includes summing the financial impact of each pain point for all users affected for each organization structure. An example of a summation of impact can include impact by job roles, areas in the enterprise, list of activities, activity tasks, area, location, etc.

Step 810 includes assigning higher weights to pain points with higher totals of impact by organization structure level. Examples of pain point weight assignment can include assignment based on financial impact by category of pain point by area, activity, task, location, etc. Example weights can take into account (i) a pain point ID, (ii) an enterprise department ID, (iii) a financial impact, and (iv) a weight factor. A weight factor can be defined by the organization based on organization and/or historical data. In some organizations, a given pain point can cause more impact than other pain points. Additionally, step 812 includes storing the weights by organization structure level in a business impact database, and step 814 includes ranking the pain points.

Ranking pain points can include reading the stored weights by category and organization structure level, and ranking each pain point by category and by organization structure. Also, such rankings can be stored by category and organization structure level in a rank database. Further, at least one embodiment of the invention includes using a multi-purpose scoring system to rank the pain points filtered by (i) category and (ii) total impact by organization structure based on the correlated impact across the enterprise.

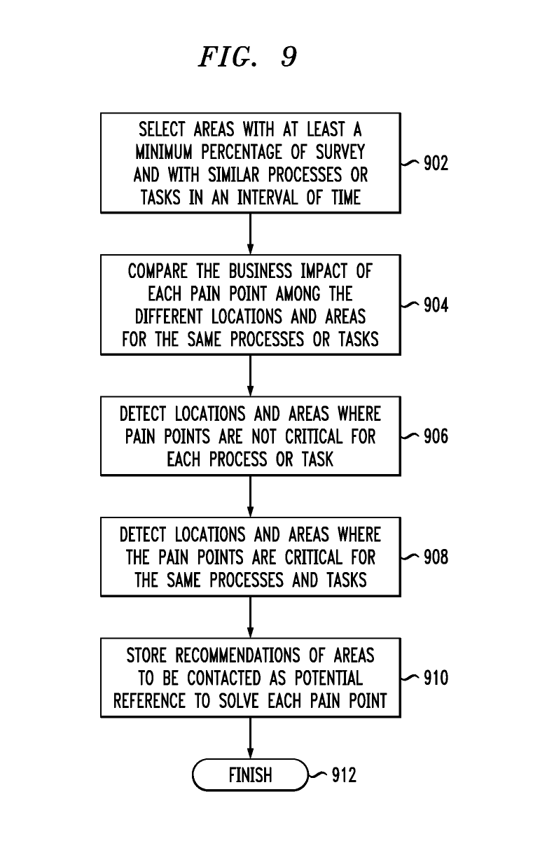

FIG. 9 is a flow diagram illustrating identifying solution opportunities, according to an embodiment of the invention. Step 902 includes selecting areas (within the enterprise) with at least a minimum percentage of survey responses and with similar processes or tasks for a given interval of time. Step 904 includes comparing the business impact of each pain point among the different locations and/or areas of the enterprise for the same processes or tasks. Step 906 includes detecting locations and/or areas where pain points are not critical for each process or task. As used herein, “critical” is defined based on the business impact detected by the user(s). Step 908 includes detecting locations and/or areas where the pain points are critical for the same processes or tasks. Further, step 910 includes storing recommendations of areas to be contacted as a potential reference for solving each pain point, and step 912 includes ending the sequence.

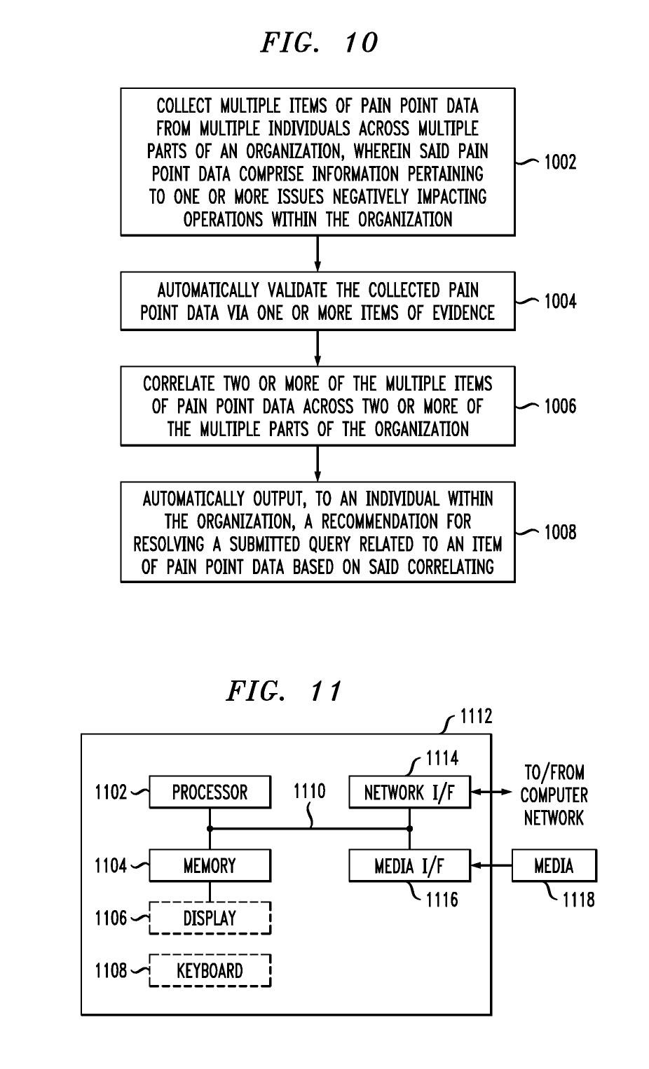

FIG. 10 is a flow diagram illustrating techniques according to an embodiment of the invention. Step 1002 includes collecting multiple items of pain point data from multiple individuals across multiple parts of an organization, wherein said pain point data comprise information pertaining to one or more issues negatively impacting operations within the organization. Collecting can include executing an automated question and answer system with the multiple individuals across the multiple parts of the organization. As also described herein, the multiple parts of the organization can include one or more geographic locations of the organization, and/or one or more substantive departments of the organization.

Step 1004 includes automatically validating the collected pain point data via one or more items of evidence. Items of evidence can include, for example, an individual ID, identification of an individual's role within the organization, an individual's location within the organization, and/or an individual's substantive department within the organization.

Step 1006 includes correlating two or more of the multiple items of pain point data across two or more of the multiple parts of the organization. Also, one or more embodiments of the invention can include storing the two or more correlated items of pain point data in a database. Step 1008 includes automatically outputting, to an individual within the organization, a recommendation for resolving a submitted query related to an item of pain point data based on said correlating. The recommendation can include, for example, an identification of an individual within the organization who previously resolved a query pertaining to a related item of pain point data.

The techniques depicted in FIG. 10 can additionally include automatically ranking the multiple items of pain point data based on one or more parameters. As detailed herein, the one or more parameters can include a cost associated with each of the multiple items of pain point data, geographic area within the organization, frequency of each of the multiple items of pain point data, and/or category of pain point data. Also, the techniques depicted in FIG. 10 can include normalizing the collected pain point data in a standardized format.

Further, at least one embodiment of the invention includes assigning a weight to each of the multiple items of pain point data, wherein the weight corresponds to a negative impact (for example, a financial impact) on the operations within the organization.

The techniques depicted in FIG. 10 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 10 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

Additionally, an aspect of the present invention can make use of software running on a general purpose computer or workstation. With reference to FIG. 11, such an implementation might employ, for example, a processor 1102, a memory 1104, and an input/output interface formed, for example, by a display 1106 and a keyboard 1108. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 1102, memory 1104, and input/output interface such as display 1106 and keyboard 1108 can be interconnected, for example, via bus 1110 as part of a data processing unit 1112. Suitable interconnections, for example via bus 1110, can also be provided to a network interface 1114, such as a network card, which can be provided to interface with a computer network, and to a media interface 1116, such as a diskette or CD-ROM drive, which can be provided to interface with media 1118.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1102 coupled directly or indirectly to memory elements 1104 through a system bus 1110. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1108, displays 1106, pointing devices, and the like) can be coupled to the system either directly (such as via bus 1110) or through intervening I/O controllers (omitted for clarity).

Network adapters such as network interface 1114 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 1112 as shown in FIG. 11) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 1102. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, normalizing elements in business process models as part of the attributes for correlating pain points across an enterprise organization, and identifying opportunities for minimizing or solving similar pain points and inefficiencies.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising the following steps:
collecting multiple items of pain point data from multiple individuals across multiple parts of an organization, wherein said pain point data comprise information pertaining to one or more issues negatively impacting operations within the organization;
automatically validating the collected pain point data via one or more items of evidence;
correlating two or more of the multiple items of pain point data across two or more of the multiple parts of the organization; and
automatically outputting, to an individual within the organization, a recommendation for resolving a submitted query related to an item of pain point data based on said correlating;
wherein at least one of the steps is carried out by a computing device.

2. The method of claim 1, comprising:
automatically ranking the multiple items of pain point data based on one or more parameters.

3. The method of claim 2, wherein said one or more parameters comprise a cost associated with each of the multiple items of pain point data.

4. The method of claim 2, wherein said one or more parameters comprise geographic area within the organization.

5. The method of claim 2, wherein said one or more parameters comprise frequency of each of the multiple items of pain point data.

6. The method of claim 2, wherein said one or more parameters comprise category of pain point data.

7. The method of claim 1, comprising:
normalizing the collected pain point data in a standardized format.

8. The method of claim 1, comprising:
assigning a weight to each of the multiple items of pain point data, wherein the weight corresponds to a negative impact on the operations within the organization.

9. The method of claim 8, wherein said negative impact comprises a financial impact.

10. The method of claim 1, wherein said collecting comprises executing an automated question and answer system with the multiple individuals across the multiple parts of the organization.

11. The method of claim 1, wherein the multiple parts of the organization comprise one or more geographic locations of the organization.

12. The method of claim 1, wherein the multiple parts of the organization comprise one or more substantive departments of the organization.

13. The method of claim 1, wherein said one or more items of evidence comprise an individual identifier (ID), identification of an individual's role within the organization, an individual's location within the organization, and/or an individual's substantive department within the organization.

14. The method of claim 1, comprising:
storing the two or more correlated items of pain point data in a database.

15. The method of claim 1, wherein said recommendation comprises an identification of an individual within the organization who previously resolved a query pertaining to a related item of pain point data.

16. A computer program product, the computer program product comprising a computer readable storage medium having program instructions embodied therewith, the program instructions executable by a computing device to cause the computing device to:
collecting multiple items of pain point data from multiple individuals across multiple parts of an organization, wherein said pain point data comprise information pertaining to one or more issues negatively impacting operations within the organization;
automatically validating the collected pain point data via one or more items of evidence;
correlating two or more of the multiple items of pain point data across two or more of the multiple parts of the organization; and
automatically outputting, to an individual within the organization, a recommendation for resolving a submitted query related to an item of pain point data based on said correlating.

17. The computer program product of claim 16, wherein the program instructions executable by a computing device further cause the computing device to:
automatically rank the multiple items of pain point data based on one or more parameters.

18. The computer program product of claim 16, wherein the program instructions executable by a computing device further cause the computing device to:
normalize the collected pain point data in a standardized format.

19. The computer program product of claim 16, wherein the program instructions executable by a computing device further cause the computing device to:
assign a weight to each of the multiple items of pain point data, wherein the weight corresponds to a negative impact on the operations within the organization.

20. A system comprising:
a memory; and
at least one processor coupled to the memory and configured for:
collecting multiple items of pain point data from multiple individuals across multiple parts of an organization, wherein said pain point data comprise information pertaining to one or more issues negatively impacting operations within the organization;
automatically validating the collected pain point data via one or more items of evidence;
correlating two or more of the multiple items of pain point data across two or more of the multiple parts of the organization; and
automatically outputting, to an individual within the organization, a recommendation for resolving a submitted query related to an item of pain point data based on said correlating.
